(19) United States
(12) Patent Application Publication
(10) Pub. No.: US 2002/0069240 A1
(43) Pub. Date: Jun. 6, 2002

(54) Method and apparatus for electronically updating printed publications

(76) Inventor: Donald J. Berk, Aurora, IL (US)

Correspondence Address: John R. Lagowski, 311 SOUTH WACKER DRIVE -53rd FLOOR, Chicago, IL, 60606, US

(21) Appl. No.: 09/731,127

(22) Filed: Dec. 6, 2000

(51) Int. Cl. G06F 15/00; G06F 15/16

(52) U.S. Cl. 709/203; 707/500; 707/104.1; 707/513

(57) ABSTRACT

A method and system for electronically updating a printed publication with data stored electronically comprises a label that is affixed to the location in the publication to be updated. The label includes a code that can be entered into a computer, terminal, or computer system, which in turn locates the data and provides the data as output.

### FIELD OF THE INVENTION

The present invention is directed at a method and apparatus for updating the contents of printed publications. Specifically, access is provided to information in an electronic database through coded adhesive labels affixed to selected pages of books, the contents of which are thereby updated.

### BACKGROUND OF THE INVENTION

Two primary concerns are driving book publishers towards replacing printed books (primarily textbooks) with electronic books (e-books). The first concern relates to the used book market. The annual market for new and used textbooks in the United States is large, currently (1999) in excess of $9 billion. Sales are split about evenly between new and used books. Booksellers, on one hand, sell both new and used textbooks, the latter through local transactions on college campuses and also remotely by mail, phone and Internet transactions. Publishers, on the other hand, sell only new textbooks, distributed primarily through booksellers, and therefore lack access to about half the total textbook market. The second concern for publishers is the increasing rate of growth in knowledge, the “content” of education. The escalating growth in content has resulted in a corresponding rise in the rate of printed textbook obsolescence, and a corresponding increase in publishing costs.

College professors and instructors have been highly resistant to the adoption of electronic textbooks. Teachers are comfortable with traditional printed books. It has proven difficult for publishers to make a convincing case to teachers to adopt e-books in the classroom. Moreover, rapid conversion to pure e-books carries high risks for the publishers regarding technical reliability and also requires high capital investment.

At the same time, booksellers, who enjoy substantial revenue from used books, are reluctant to lose that business to e-books, which can be continually updated electronically and therefore always new. Second-hand books are in fact more profitable than new books for booksellers.

While professors and instructors appear satisfied with paper textbooks as the backbone of their courses, it is a time-consuming and tedious task for them to organize and distribute the wide variety of ancillary study materials that accompany the textbook. These include but are not limited to articles, reports, commentaries, charts, quizzes, bibliographies and addendum.

Most students today are comfortable with accessing electronic data sources, such as conventional databases and the Internet, and are able to conduct useful research online. However, the computer is still not as portable or as convenient for study as a book. Until technology makes improvements in portable devices, the textbook will most likely remain the central resource of choice by professors and students for most courses. The problem is in efficiently locating additional online information related to printed book content.

Recently introduced Internet (World Wide Web—“www”) “search engines”, such as Google, help by allowing a student to search on-line indices of information sources, and even full source text, for relevant key words and phrases related to their textbook topic of interest. Even carefully structured queries by experienced users, however, often result in hundreds and even thousands of possible “hits” which are not sufficiently specific to preclude further manual search, which is both data resource inefficient and time consuming. Moreover, human readable printed source addresses, and especially URL's, are difficult to manually enter in software programs, such as web browsers, due to their length and use of complex and unfamiliar symbols. If the characters in a URL are not entered exactly, retrieval is prevented or, in a limited number of cases, a legal but incorrect source is accessed. This is especially true when URLs incorporate foreign languages and/or complex query instructions to on-line databases, as is increasingly frequent in most Web sites. Furthermore, once relevant information has been located through a URL, a problem may arise as to how to retain a persistent link between the online information and the exact place in the textbook to which it pertains. Students may write the URL on the textbook page or create a database for storing the linkage information, both methods further exacerbating the problem of manual transposition of complex codes. In addition, the inability to type or otherwise manually enter lengthy symbolic address information due to either disability or lack of training complicates for millions of people the use of on-line information resources such as the Internet.

Companies that host Web sites for the purpose of providing educational information, often want to know the identity and other related information of the users who visit their sites (i.e., download files therefrom). It would be quite advantageous to provide such companies or vendors with this information as part of a specific file transfer request, e.g., as part of a CGI parameters string included in a URL. Additionally, it would be desirable to be able to effect a secure manner of transferring this information, so that a user would have confidence in the system and thus send sensitive information such as a credit card number or the like with the file transfer request. This would enable electronic commerce to flourish in education well beyond the point it exists today.

The present invention provides a method and apparatus for updating the content of printed publications and may be especially useful for addressing the concerns and problems discussed above as well as other problems involved in publication supplemental data dissemination as experienced by publishers, teachers/professors, students, and others.

### SUMMARY OF INVENTION

The present invention is directed at a system and method for providing access to electronic information stored in databases in either remote or local locations via codes applied to selected pages of printed publications (typically used textbooks). Such printed publications may include used books of any kind, such as textbooks, novels, Bibles, biographies, or reference books, etc. Textbooks may be those assigned as part of a study program in a public or private school, college or educational institution, or an internal organizational training department, etc. The system of the present invention utilizes a code printed on or contained in an adhesive label (the data carrier), referred to herein as an intelligent footnote. Information used to automatically access stored electronic information is recorded on the intelligent footnote. The code, which may be a character string or a symbol, such as Braille, comprises encoded source data, wherein the source data comprises file location information. The source data is encoded and rendered on or attached to adhesive labels. The adhesive labels are distributed to the book owner/reader and affixed/attached to designated pages of the designated textbook (identified by ISBN or other unique code).

The code is decoded into (preferably) file location information when entered into a client computer or network-connected device via a keyboard or appropriate code recognition equipment. The file location information provides access to the appropriate file, i.e., the stored electronic information.

The encoded label thus serves as an intelligent footnote at selected pages of a used book and effectively extends the content of printed textbooks by providing an accurate and efficient path to virtually unlimited electronic content. In a preferred embodiment, a Web browser program is launched, and the URL of the vendor's Web site, which includes the stored electronic information, is accessed through the Internet. Local file retrieval may also be implemented on the client computer itself, as well as over an intranet or LAN environment. Additional data, such as a user's identification and password, may also be encoded in the label when the system is part of a secure electronic commerce service.

### BRIEF DESCRIPTION OF THE DRAWINGS

FIG. 1 is a block diagram representation showing the relationship between several components of the system of the present invention.

FIG. 2 shows an example of a label of the preferred embodiment affixed to a page in a book.

FIG. 3 shows a preferred format for a label set of the preferred embodiment.

FIG. 4 shows a preferred format for a browser data entry screen for capturing label codes.

FIG. 5 shows a preferred format for a client browser screen for returning supplemental data keyed to a footnote label.

FIG. 6 is a flowchart of one potential application of the present invention.

FIG. 7 is an overview of a system diagram for the application of FIG. 6.

### DETAILED DESCRIPTION OF THE PREFERRED EMBODIMENTS

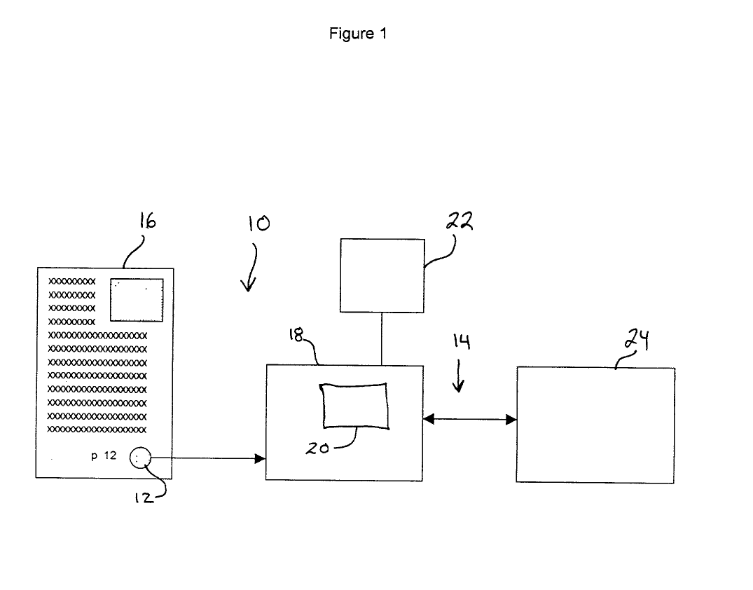

Referring to FIG. 1, the electronic updating system 10 of the present invention includes a label 12, and a data processing system 14. The label 12 preferably has an adhesive backing such that it may be easily affixed to a page 16 of a printed publication (hereinafter referred to as a “book” for convenience). The label may be affixed or otherwise associated with a page of a book through other means as well, such as tape, paperclip, tack, or other device. The label 12 has data thereon to be used by the data processing system 14 for accessing and/or locating supplemental data associated with the page 16, as discussed below.

The data processing system 14 includes a user interface and processing system 18, such as a client computer in a networked computer system. The user interface and processing system preferably includes a monitor 20 and a printer 22 associated therewith. The processing system is configured to receive (though a keyboard, scanner, or other input device) the data or a portion of the data on label 12, as discussed below. The processing system utilizes the data to retrieve information from database 24.

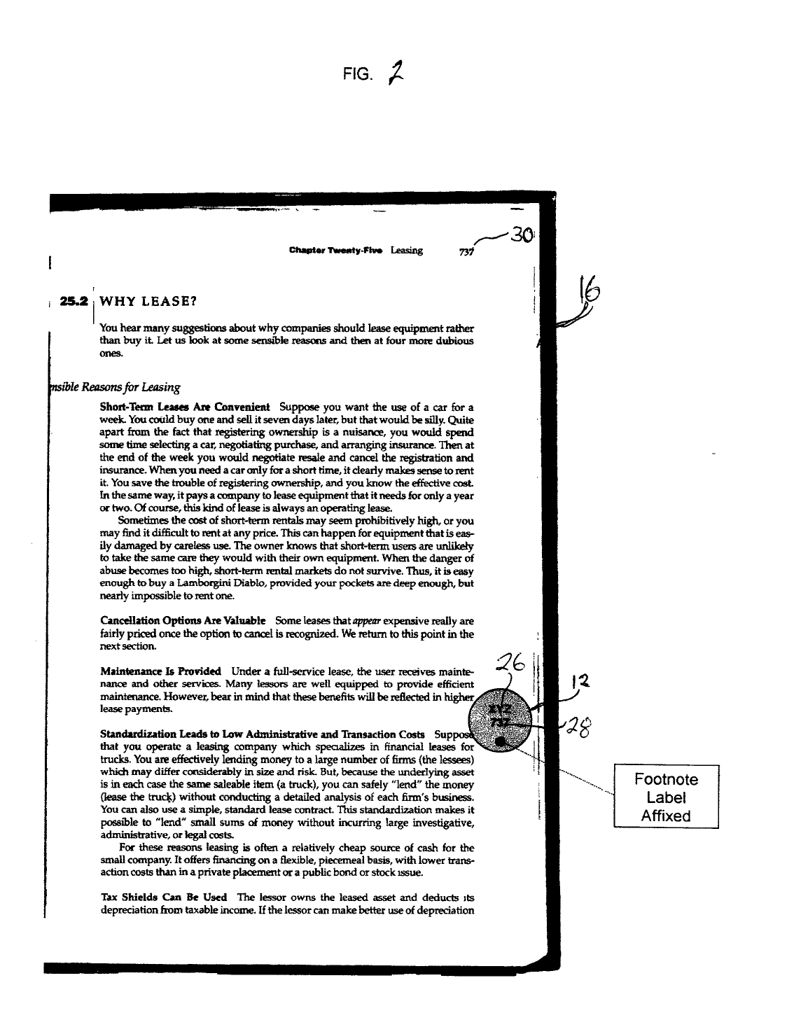

A label 12 of the preferred embodiment is shown in FIG. 2 affixed to a page of a book. The label 12 in this embodiment is an adhesive footnote label (occasionally referred to herein as a “data carrier”) that includes a code 26 and a page number 28. The page number 28 matches the number 30 of the page of the book to which the label is affixed. The page number 28 is preferably provided on the label for convenience, to assist a user in identifying the page to which the particular code/adhesive label belongs. In an alternate embodiment, no page number is provided on the label. Instead, the page to which each label is associated with is provided on a reference sheet separate from the label itself.

The code in the embodiment shown includes a string of three characters, XYZ, which may be referred to as a meta-code. The processing system 18 receives the code through user input, preferably a keyboard. In response to receiving the code, the processing system preferably identifies a corresponding file location pointer. The file location pointer, in turn, preferably points to the location in the database 24 having the supplemental page information. The computer parses the input data string to determine the file location pointer, and the file location pointer is then utilized to request the computer file designated thereby.

The client computer may utilize the file location pointer to request the computer file by passing it to an application program suitable for processing the corresponding computer file. In this embodiment, the application program retrieves the computer file from the specified file location. In an alternate embodiment, the client computer utilizes the file location pointer to request the computer file by retrieving a copy of the computer file from the specified file location. An application program is then invoked on the client computer for processing the corresponding computer file.

In the preferred embodiment, the client computer assembles a computer file transfer request word that includes the file location pointer. The request word is transmitted to a target server computer over a computer network system, which may be a wide area network such as the Internet or a local area network (LAN) or intranet. In an alternate embodiment, the file location pointer itself specifies the location of a computer file stored in a local memory resident in the client computer.

If the computer file to be retrieved is on a target server computer on a network, it is preferred that the file location pointer is a network address associated with the target server computer and a file identifier correlated to the requested computer file. In particular, when utilizing the Internet, the file location pointer may be in the form of a uniform resource locator (URL). In any type of networked environment, the target server computer may receive the computer file transfer request word and responsively transmit a computer file to the client computer.

Preferably, a source identifier data string is encoded within the meta-code. The source identifier data string preferably denotes the particular source of the data carrier, such as a textbook ISBN. The source identifier data string may also identify a user or targeted group of users. In this embodiment, the source identifier string is transposed by the client computer, assembled within the computer file transfer request word, and transmitted to the target server computer. The target server computer stores the source identifier data string received from the client computer in the computer file transfer request word.

The meta-code may also have encoded therein an encryption key associated with the source identifier data string. The encryption key is transposed by the computer input device and used by the client computer to encrypt information specific to a user of the client computer. The encrypted user information is assembled within the computer file transfer request word and transmitted to the target server computer. The information specific to a user may be obtained, prior to encryption, from a user information data file stored on the client computer, or it may be obtained from user demographics data correlated to a targeted user of the data carrier that may have been previously encoded within and transposed from the machine readable symbol, for example. The target server computer may utilize the source identifier data string to access a lookup table to determine a decryption key, and then decrypt the encrypted user information received from the client computer in the file transfer request word. The lookup table may be stored locally on the target server computer, stored remotely on a secondary server computer, or accessed by some other means known in the art.

The decrypted user information may comprise sensitive user information such as a credit card number, thus enabling an online electronic commercial transaction. The target sever computer may use the user demographics data to determine the file to transmit to the client computer; i.e. specific files may be correlated to specific users.

The meta-code may also have encoded therein an executable command to launch a software utility resident on the client computer. Preferably, the software utility is automatically launched after the meta-code is transposed. For example, the software utility may be an Internet browser program or a word processing program. In addition, specific functions may also be encoded in the meta-code along with the application launch command, such as a command to execute a print job for printing the retrieved computer file.

The symbol-data string may be obfuscated prior to being encoded into the meta-code, in which case the input string transposed must likewise be de-obfuscated by the client computer. The obfuscation may be by computing a checksum of the symbol data string, encrypting the symbol data string by utilizing the checksum as an encryption key, and assembling the checksum with the encrypted symbol data string prior to encoding into the machine-readable symbol. The de-obfuscation may be accomplished by parsing the input data string to determine the checksum, decrypting the encrypted symbol data string with the checksum as a decryption key, computing a checksum of the decrypted symbol data string, and comparing the computed checksum with the checksum from the input data string. A valid data condition may preferably be indicated when the comparison step is successful; and an invalid data condition may preferably be indicated when the comparison step is unsuccessful.

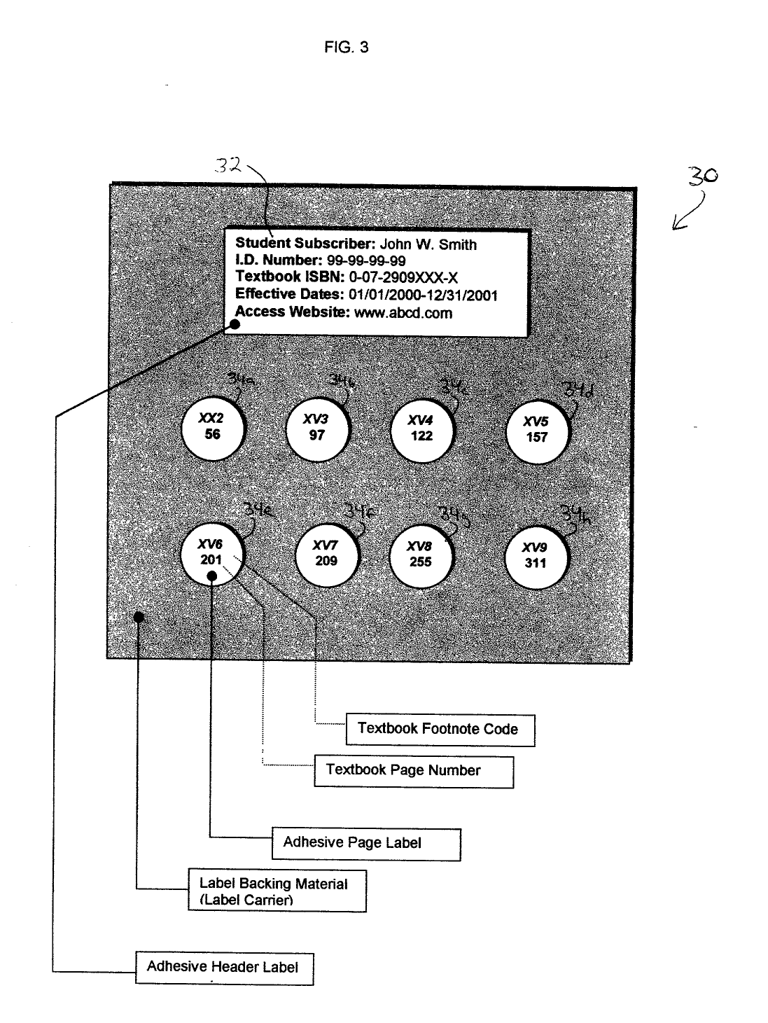

In the preferred embodiment, adhesive labels are distributed in sets or groups of meta-codes, wherein each set or group corresponds to all or most of the pages to be updated with supplemental information or data. An encoded adhesive footnote label set 30 of the preferred embodiment is shown in FIG. 3. The label set comprises a header label 32 and a plurality of adhesive labels 34(a)-34(h). In the embodiment shown, the header label includes a subscriber identification field, an identification number field, a textbook ISBN field, an effective dates field, and a field for providing the address of the website for accessing the supplemental information. Each page label 34(a)-34(h) and the header label 32 is adhesive and adheres to a label backing material. Each page label preferably includes a publication page footnote code (meta-code) and a publication page number.

The footnote labels depicted in FIG. 3 may be produced as system output from a computer or may be produced by some other means known in the art. The set of labels typically consists of a single header label, which may be affixed on any convenient page or cover of the textbook, and one or more footnote labels, which are affixed to designated pages. For convenience, all the labels will typically be mounted on a peel-off backing, so that they may easily be separated and affixed to their designated places in the textbook. The header label preferably contains information identifying the student subscribing to the service, the designated textbook, database access codes and other control specifications, such as the period in which the service is effective. Footnote labels are preferably rendered with brief footnote codes and textbook page numbers or page locations. The footnote codes are those codes to be entered into the client computer in order to begin the process of retrieving footnote information from the server computer(s).

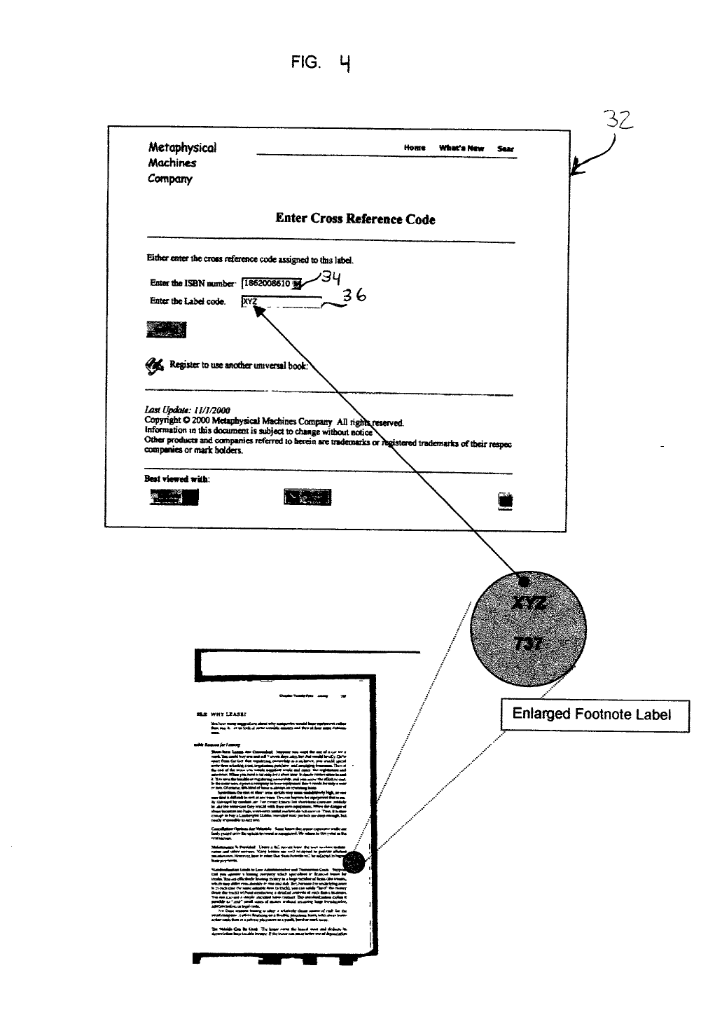

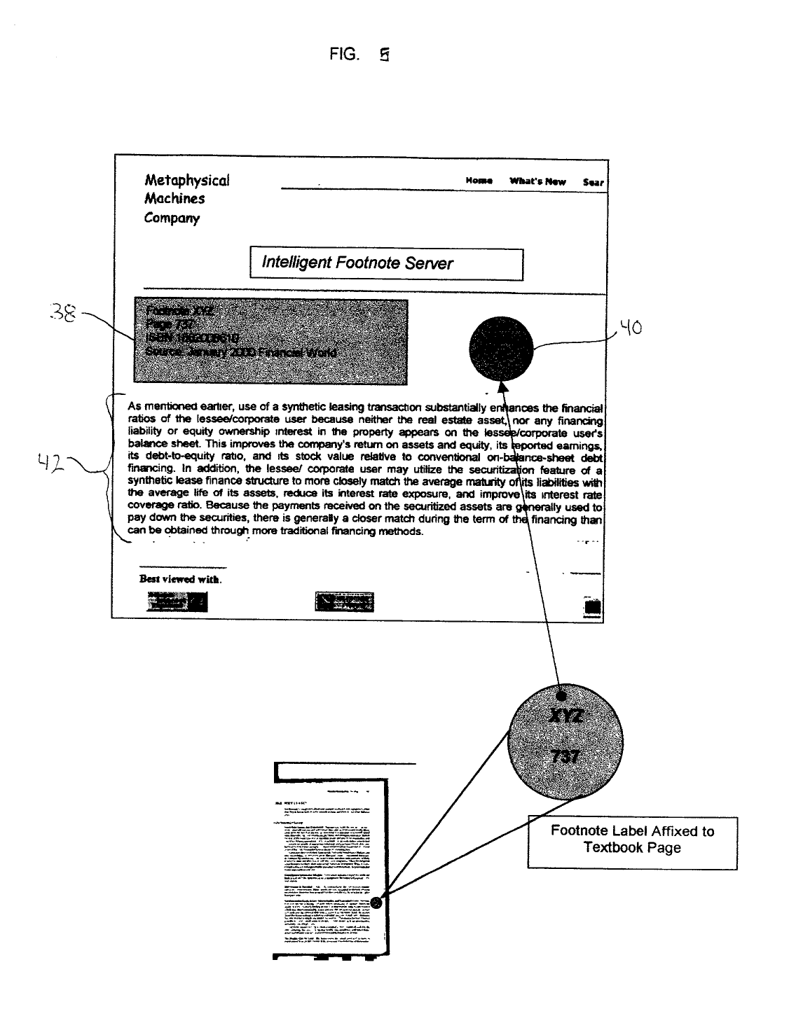

A preferred format for a browser data entry screen is shown in FIG. 4. As shown, the preferred data entry screen includes an ISBN data entry field 34 and a label code field 36. As illustrated, the label code entered on the browser screen in this example matches the textbook footnote code “XYZ” for page 737 of a publication having an ISBN number of 1862008610. After the ISBN number and label code are entered, clicking the “submit” button prompts a screen having the supplemental information for the respective page, shown in FIG. 5.

The supplemental information page of the preferred embodiment includes an information identification section 38, a footnote icon 40, and an information section 42. The information identification section 38 shows the footnote code, page number, ISBN number, and identifies the source of the supplemental information 42. The supplemental information in this example is textual. Of course, supplemental information may comprise any one or several of many types of content, such as pictures, tables, graphs, animation, sounds, or movies. As illustrated, the footnote icon 40 provides an easy way for a user to verify that the correct page has been accessed, as the footnote icon 40 matches the label affixed to page 737 of the publication. The information that is returned from the server may be in any electronic form suitable to the purposes of the student and service vendor, such as hypertext markup language (HTML) documents, XML documents, or files containing text, audio, graphics, animation, etc.

One application in which the present invention may be particularly suitable is the academic textbook market. Although, it is obvious to those skilled in the art that the applicability of the present invention is not limited to the academic textbook market. The present invention may be used for updating any type of printed publication.

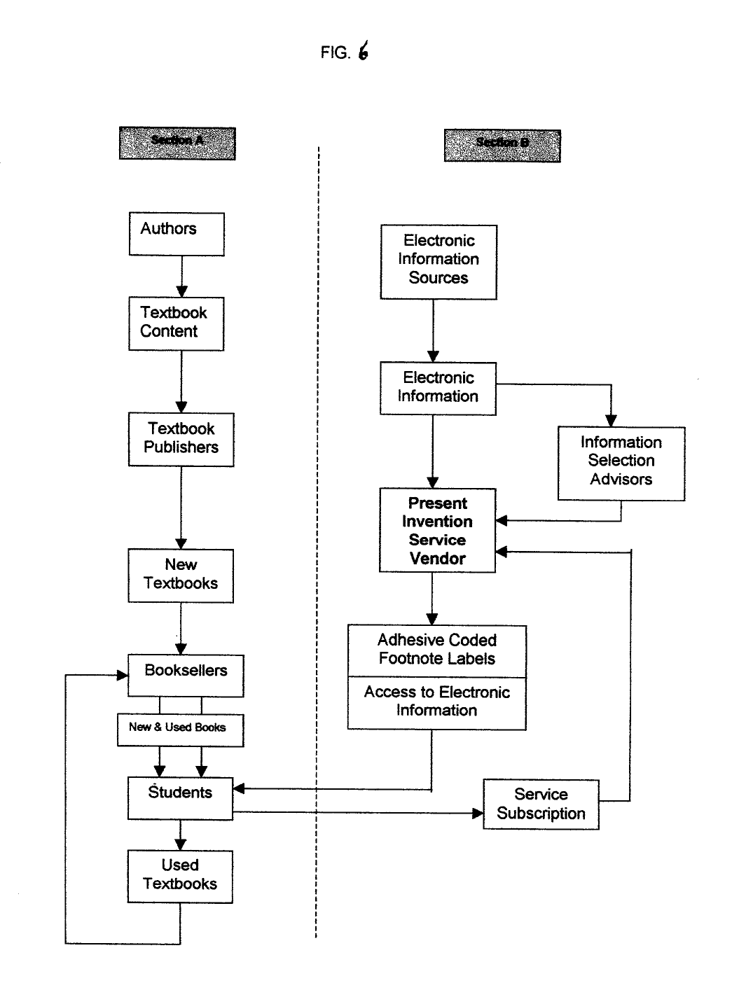

In one particular application, used textbooks may be updated by linking pages of the used textbooks to electronic information through coded adhesive labels. The typical life of a textbook (prior art) is illustrated in Section A of FIG. 6. In the conventional flow of textbook publishing, authors provide content to textbook publishers. Textbook publishers produce new paper textbooks and wholesale them to booksellers. Booksellers retail the new textbooks to students. When finished with textbooks, students may sell them back to booksellers, thus providing a supply of used textbooks for the used textbook market.

In the example shown, the utility of a used textbook can be extended by supplementing the contents thereof with data accessed through the use of the present invention. Publishers may participate in the used textbook market by providing (and limiting) access to and the contents of supplemental information. The publisher may, for example, program certain parameters to be encoded in meta-code and rendered on an adhesive label. An example of such a service is illustrated in Section B of FIG. 6.

A probable scenario may be as follows: A publisher, or other vendor, determines from educational advisors, such as professors and publishers, or others what electronic information is designated or desired for inclusion in the databases and/or Internet sources for each updateable page of a used textbook. The updateable pages are thereby identified, as well as the location for the update within each page. The access information is then encoded to the information sources, along with other encoded information as needed to perform the service, and the encoded information is rendered on adhesive labels. A vendor may then offer, through traditional advertising and distribution channels, a service to students whereby the students may obtain footnote labels to place in their textbooks and thereby gain access to the supplemental information.

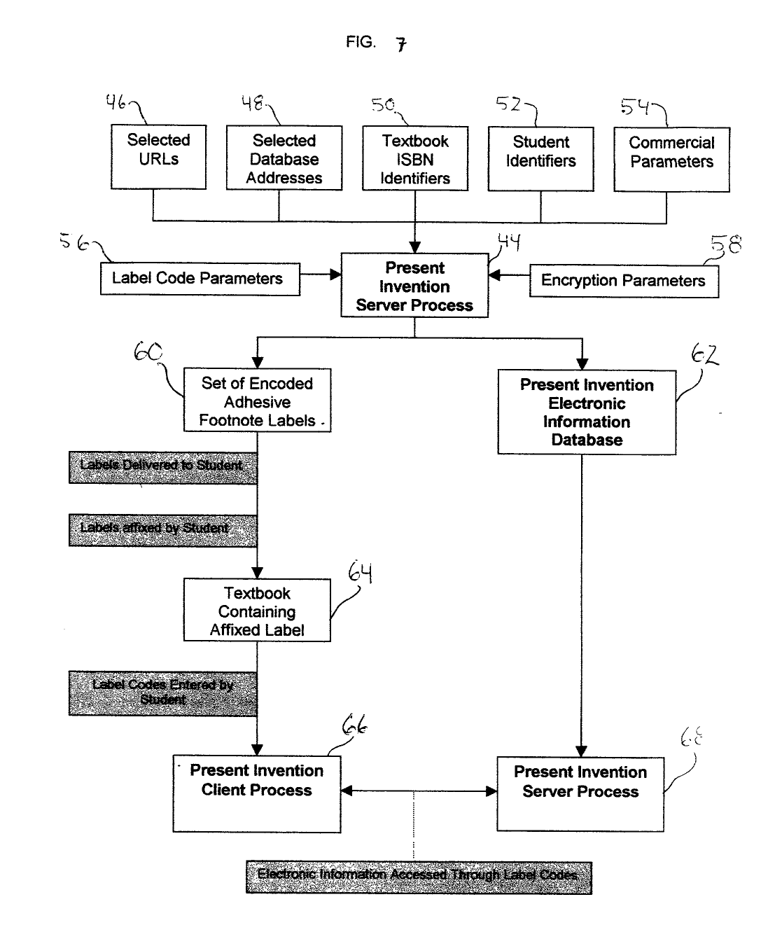

An illustration of one method of using the system and method of the present invention is provided in FIG. 7. A server process 44 collects information from a variety of sources. Such information may include one or more URLs 46 for providing the service, selected database addresses 48 that contain the supplemental data, textbook ISBN identifiers 50 for identifying the books to be updated, student identifiers 52 for controlling access to the supplemental data to selected individuals or subscribers, and commercial parameters 54. The server process 44 also receives label code parameters 56, such as textbook footnote codes, and encryption parameters 58 so that the system can be accessed through secure communication channels.

The server process 44 is programmed to generate two primary outputs. One output is a set of adhesive footnote labels 60 rendered with meta-codes. The other primary output is an electronic database 62 containing either the footnoted information pointed to by the meta-codes or the source identifiers of the footnoted information; the textbook identifiers; the student identifiers; and other information required to establish a connection between the client and server computers and to execute the processes.

The adhesive labels are provided to the students subscribing to the service. The labels may be physically delivered to or retrieved by the student or an electronic representation can be transposed and output into physical media on a client computer Upon obtaining a label or set of labels, the labels are applied to the designated pages according to information provided with or rendered on the labels. Once textbook labels have been affixed, a student may readily reference and access either local or remote databases by establishing a session using client software 66 or an Internet browser. As directed by the server software 68, students enter footnote codes from textbook labels into the client as desired in order to retrieve the information directly associated with the labeled portion of the textbook.

While the invention has been particularly shown and described with reference to certain preferred embodiments, it will be understood by those skilled in the art that various alterations and modifications in form and in detail may be made therein without departing from the spirit and scope of the invention.

1. A method for providing access to supplemental data for at least one page in a printed publication, said method comprising:
providing an electronic database that includes supplemental data for said at least one page, said supplemental data provided at least at a first location in said database and accessible from at least a first computer system;
generating an index having a first parameter for identifying said at least one page and having a second parameter associated with said supplemental data and said first parameter for input to said computer system; and
providing instructions for said first computer system, wherein said first computer system is programmable in accord with said instructions for retrieving said supplemental data for said at least one page in response to receiving at least said second parameter.

2. The method of claim 1 wherein said first computer system is an Internet and wherein said second parameter is a meta-code for input into said Internet.

3. The method of claim 2 wherein said Internet includes at least one client computer and at least one server computer, said client computer for receiving said meta-code and for responsively generating a file transfer request word and directing said file transfer request word to said at least one server computer of the Internet.

4. The method of claim 1 wherein said second parameter comprises an encoded file location pointer comprising a uniform resource locator (URL) for specifying said first location in said database.

5. The method of claim 1 wherein said first computer system is an Internet that includes at least one client computer and at least one server computer, wherein said second parameter comprises an encoded file location pointer comprising a network address associated with at least one server computer and a file identifier correlated to said first location in said database.

6. The method of claim 1 wherein said index comprises an adhesive label and said second parameter comprises a character string.

7. The method of claim 3, further comprising:
encoding in said index an encryption key associated with a source identifier data string, said encryption key suitable for receipt by said client computer to encrypt information specific to a user associated with said client computer, said encrypted user information suitable for assemblage within a computer file transfer request word and transmission to said server computer.

8. The method of claim 7 wherein said server computer utilizes a source identifier data string to access a lookup table to determine a decryption key associated with said encryption key, and said server decrypting said encrypted user information received from said client computer.

9. The method of claim 8 wherein said lookup table is stored remotely on a secondary server computer.

10. The method of claim 1 further comprising a server process, said method further comprising the steps of:
providing to said server process data including the ISBN number of the printed publication to be updated, a list of user identifiers, at least one URL, the address of said at least first location in said database, and at least one label code parameter;
generating by said server process said index; and
establishing by said server process an electronic information database.

11. A system for supplementing the contents of a book, said system comprising:
a first label having indicia associated therewith for ascribing said first label to selected contents of a selected page of said book, said first label further comprising a contents code;
an electronic database having a contents code field and a contents field including supplemental information to said selected contents; and
a computer system for receiving said contents code and retrieving said supplemental information, wherein said contents code is suitable for use with said computer system for indicating the correspondence between the selected contents and the supplemental information.

12. The system of claim 11 wherein said computer system is an Internet and said contents code comprises a file transfer request word.

13. The system of claim 12 wherein said contents code comprises an encoded file location pointer comprising an uniform resource locator (URL) for specifying an address in said database having said supplemental information.

14. The system of claim 11 wherein said book is an academic textbook.

15. The system of claim 12, further comprising:
at least one client computer; and
at least one server computer, wherein said client computer is configured for receiving a meta-code and for responsively generating a file transfer request word and directing said file transfer request word to said at least one server computer of the Internet.

16. The system of claim 11, further comprising:
a set of encoded adhesive footnote labels mounted on carrier material, said set of labels including said first label and wherein said first label includes a textbook footnote and a textbook page number.

17. The system of claim 13, further comprising:
an encryption key associated with a source identifier data string, said encryption key suitable for receipt by said client computer to encrypt information specific to a user associated with said client computer, said encrypted user information suitable for assemblage within a computer file transfer request word and transmission to said server computer.

18. The system of claim 17, further comprising:
a source identifier data string to access a lookup table to determine a decryption key associated with said encryption key, and said server decrypting said encrypted user information received from said client computer.

19. A set of encoded adhesive footnote labels comprising:
a plurality of page labels, wherein each said page label includes a string of characters comprising a footnote code and a numerical indication of a page number; and a label header for identifying a textbook to which said footnote codes pertain.

20. A system for retrieving supplemental information for a printed publication, said system comprising:
generating means for providing an index identifying updateable locations in the printed publication and for providing a plurality of codes for locating the supplemental data that corresponds to the updateable locations; and
data processor means programmed for receiving at least one of said codes and for responsively providing said supplemental information.
